(19) United States
(12) Patent Application Publication
(10) Pub. No.: US 2005/0060130 A1
(43) Pub. Date: Mar. 17, 2005

(54) Modeling and analysis of objects having heterogeneous material properties

(76) Inventors: Vadim Shapiro, Madison, WI (US); Igor G. Tsukanov, Madison, WI (US); Arpan Biswas, Sodpur (IN); Michael K. Freytag, Sun Prairie, WI (US)

Correspondence Address: Intellectual Property Department;DEWITT ROSS & STEVENS S.C., US Bank Building, 8000 Excelsior Drive Suite, 401, Madison, WI, 53717-1914, US

(21) Appl. No.: 10/896,407

(22) Filed: Jul. 22, 2004

Related U.S. Application Data
(60) Provisional application No. 60/490,356, filed on Jul. 25, 2003.

(51) Int. Cl. G06F 17/10

(52) U.S. Cl. 703/2

(57) ABSTRACT

A method is described for modeling heterogeneous material properties within a geometric model of an object (e.g., within a CAD model). Material functions are defined about material features (i.e., points, surfaces, or areas on or in the model) at which material properties are known, with the material functions each defining the behavior of that feature's material property at locations away from that feature. Combination of the material functions results in a single material function which defines the material properties throughout the geometric model. The resulting material function may then be used in subsequent analyses, such as in computerized behavior analysis of the geometric model. The material function may be constructed such that it meets desired constraints, and has desired smoothness and analytical properties, for ease of use in such subsequent analyses.

### CROSS-REFERENCE TO RELATED APPLICATIONS

This application claims priority under 35 USC § 19(e) to U.S. Provisional Patent Application 60/490,356 filed 25 Jul. 2003, the entirety of which is incorporated by reference herein.

### STATEMENT REGARDING FEDERALLY SPONSORED RESEARCH

This invention was made with United States government support awarded by the following agencies:

NSF Grant No(s).: 0115133

The United States has certain rights in this invention.

### FIELD OF THE INVENTION

This document concerns an invention relating generally to engineering design, modeling and analysis of objects having heterogeneous material properties, and more specifically to design, modeling, and analysis of geometric models (e.g., CAD models) of such objects.

### BACKGROUND OF THE INVENTION

Geometric modeling of objects, and the analysis of the behavior of the modeled objects, are extremely important activities in engineering and related fields. Modeling is generally performed by constructing a representation of an object's geometry on a computer (i.e., a CAD geometric model), with the representation including the “environment” of the object (that is, the object's boundary conditions, such as loads exerted on the object, temperatures on and around the object, and other physical and non-physical functional values). The analysis of the model's behavior is then usually also performed by computer, with the goal of predicting the modeled object's physical behavior based on the boundary conditions defined for the geometric model. In general, this involves determining physical functional values and/or their derivatives everywhere in the geometric model, both on its boundaries and in its interior, based on the known boundary conditions defined at isolated locations on the model. The two activities of modeling and analysis are highly interrelated in that modeling is the prerequisite for analysis, while results of analysis are often used for further modeling.

One problem with conventional modeling and analysis techniques is that once an object is modeled in the geometric domain, it must then be “re-modeled” in the functional domain for analysis to occur. This is generally done by discretizing the model, e.g., defining a mesh or grid which divides the overall model into finite elements (with these elements generally conforming to and approximating the overall model). Discretization is a time-consuming and difficult chore, and it requires careful attention since the type, coarseness/fineness, and manner of discretization can have a significant effect on the results of analysis.

Another problem with conventional modeling and analysis techniques is that they have been developed under an assumption that the object being modeled has homogeneous material properties, i.e., physical properties (such as density, melting and boiling temperatures, etc.); mechanical properties (such as elastic modulus, shear modulus, poisson's ratio, tensile strength, etc.); thermal properties (such as coefficient of thermal expansion, thermal conductivity, specific heat, etc.); electrical properties (such as resistivity, conductivity, dielectric constant, etc.); optical properties (index of refraction, etc.); and so forth. In cases where discretization techniques are used, conventional modeling and analysis techniques assume that material properties are homogeneous within each element defined by the technique. Previously, these assumptions were acceptable because the objects in question did have at least substantially homogeneous material properties; for example, an automotive part being engineered would be constructed of a single material (e.g., a particular grade of steel), and would be modeled as such. However, with recent advances in materials science and engineering, it is now common for materials to have heterogeneous material properties. To illustrate, objects made of composites and thin film (layered) materials are now common, and emerging technologies allowing functionally graded materials and local material composition control (such as photopolymer solidification, material deposition, powder solidification, lamination, and other layered manufacturing methods) are expected to become commonplace. Proper engineering of the material properties of an object can allow weight reduction, improved structural and other mechanical properties, improved heat transfer, the possibility of embedded functionality (e.g., integrally built-in sensors and controls), and other benefits. To illustrate, biomedical implants (e.g., prosthetic hip and dental implants) were once made of a single material, with homogeneous properties, and these often required frequent replacement over a patient's lifetime owing to erosion or mechanical failure, bonding failure, or rejection. However, with the foregoing advances in materials science, such implants can be engineered to have the desired degree of strength and wear resistance, bonding with bones, and biocompatibility, and to last for the patient's entire lifespan. Such advantages would not be possible without the ability to vary material properties locally and globally.

In order to take full advantage of these developments in materials engineering, there is a need for improved methods of computer-aided representation, design, analysis, and manufacturing process planning of objects having heterogeneous properties. As noted above, the task is non-trivial because the modern geometric and solid modeling technology has been developed under assumptions of material homogeneity. Where material properties vary discretely in an object, it can be modeled using conventional techniques in a fairly straightforward manner: it can be defined as a series of regions with adjoining boundaries, with each region representing a section of the object having discrete (and homogeneous) properties. However, there is a lack of modeling techniques available for objects having heterogeneous material properties. Some techniques are reviewed in Kumar et al., “A framework for object modeling”, Computer-Aided Design, 31:541-556 (1999), but most are difficult to implement and/or are computationally impractical.

### SUMMARY OF THE INVENTION

The invention, which is defined by the claims set forth at the end of this document, is directed to methods allowing effective modeling of objects with heterogeneous material properties in a rigorous and computationally effective manner that appears to encompass most practical modeling problems. The method allows a computer-aided design system (or similar systems) to model the material properties of a geometric model of an object, wherein material properties are known at one or more material features (i.e., points, surfaces, or areas on or in the model), and wherein material properties are undefined at other locations of the model. One or more material functions are defined, each corresponding to one of the material features, and each being a function of a distance field (distance function)—a function which encodes information regarding the distance between a feature and other points in space—such that each material function defines the value of a material property as a function of the distance from a material feature having that material property. Thus, the material functions efficiently encode information regarding geometry, material properties, and their distribution, all as functions of distance from the material features. The individual material functions for the material features can then be combined, as by interpolating them between their material features, to construct a single material function which defines the material properties throughout the geometric model. The resulting material function can then be used in subsequent modeling efforts (e.g., in standard CAD behavior analyses of the model, or in meshfree behavior analyses of the model, as discussed in U.S. Pat. No. 6,718,291 to Shapiro et al. Alternatively, the previously-undefined material properties at the locations away from the material features may be determined by use of the material function and output to the user.

Note that the material property values defined by the material function at the locations on the geometric model away from the material features may or may not represent the real-world material property values on the real-world object being modeled; these would need to be determined by testing of the real-world object. The fundamental benefit of the invention is in its ability to present a material property model, in the form of the material function, which is derived without the need to discretize the geometric model, which may have desired analytic properties (e.g., differentiability at some or all locations), and which can be used in later behavior analyses of the model (either without or with discretization).

The user of the computer system may control the behavior of the material function so that material property values vary in some desired fashion (e.g., to better meet expected real-world material property values) by altering the influence of one of more of the material features on the interpolation process, e.g., by weighting the distance fields of the material features differently during the interpolation process. As will be discussed later in this document, inverse distance weighting, or other forms of weighting wherein the influence of the distance field of each material feature decreases in accordance with the distance from that material feature, are particularly preferred methods of weighting. Further, the material function may be constrained to meet user-desired constraints—e.g., some algebraic, differential, integral, stochastic, or other requirements—to a desired degree of accuracy by solution of unknown coefficients of basis functions. Thus, a user is able to define a material function (in essence, a material property model of the object) which fully defines the material properties of an object in the functional domain, and which may behave in such a manner that the material function is readily usable in subsequent analyses.

The invention is based on the proposition that the modeling of properties constitutes a special type of boundary value problem whose solution is parameterized by the distance fields of the material features of an object (i.e., features of the modeled object having defined material properties). Further details regarding the background and uses of the invention can be found in A. Biswas, V. Shapiro and I. Tsukanov, Heterogeneous Material Modeling with Distance Fields, Computer-Aided Geometric Design, Vol. 21 (2004), Pp. 215-242 and in A. Biswas and V. Shapiro, Approximate Distance Fields with Non-Vanishing Gradients, Graphical Models, Vol. 66, Issue 3 (May 2004), Pp. 133-159, as well as in U.S. Pat. No. 6,718,291 to Shapiro et al., with all of these references being incorporated by reference herein.

Further advantages, features, and objects of the invention will be apparent from the following detailed description of the invention in conjunction with the associated drawings.

### BRIEF DESCRIPTION OF THE DRAWINGS

FIG. 1(a) illustrates a material function F defined about an S-curve, with the material function being represented by a Taylor series expansion in the powers of the distance field u.

FIG. 1(b) displays the value of an exemplary material function F(u)=e^{(-1.5)u} in terms of the distance u to the S-curve of FIG. 1(a).

FIG. 2(a) displays the explicitly constructed material function F(u)=1−u².

FIG. 2(b) displays the algebraic constraint function

$$F ( P ) = ( 1 - \frac{u}{1 + u} ) ;$$

as u→∞, f(u(p))→0.

FIG. 2(c) displays the least square fit of the material function in FIG. 2(a) to the constraint function in FIG. 2(b).

FIG. 2(d) displays the function F(u) that minimizes the functional ∫_{Ω}(∇F+2)²dΩ, with F₀=1−u².

FIG. 3 schematically depicts the problem of determining a combined material function from the individual material functions of individual features, with weights Wᵢ being made dependent on the distances uᵢ.

FIG. 4 depicts the results of transfinite inverse distance interpolation of the material functions in FIG. 3.

FIG. 5 shows the results of weighted transfinite inverse distance interpolation of the material functions in FIG. 3 using influence functions λ₁=e^{60u}^{ᵢ} and λ₂=1.

FIG. 6(a) shows the object of FIG. 3 being formed of a composition of three materials, defined about the material features of FIG. 3, and with global material fraction functions constructed using inverse distance interpolation.

FIG. 6(b) shows the object of FIG. 3 being formed of a composition of three materials, defined about the material features of FIG. 3, and with global material fraction functions constructed using weighted inverse distance interpolation with distinct influence functions for each feature.

FIG. 7 is a diagram of the data processing within a system combining the material property modeling system of the present invention with the meshfree behavior analysis system of U.S. Pat. No. 6,718,291 to Shapiro et al.

FIGS. 8(a)-8(e) show a hypothetical loaded plate devised for processing by the combined material property/behavior modeling system of FIG. 7 (in FIG. 8(a)); plots of the distance fields constructed from the constrained sides (material features) in FIG. 8(a), for the material property of stiffness (Young's modulus) (FIGS. 8(b) and 8(c)); a plot of the variation in Young's modulus calculated to reduce the stress concentration between the constrained sides (FIG. 8(d)); and a plot of the principal stress (FIG. 8(e)).

### DETAILED DESCRIPTION OF PREFERRED VERSIONS OF THE INVENTION

A. Material Features, Material Functions, and Constraints

The invention assumes that one is provided with a geometric model of an object (or features of an object) with certain defined material property constraints (i.e., material properties are known/defined at one or more locations on the model). The task is then to define one or more material functions—a representation of a material property—that varies (usually continuously, but sometimes discretely) from point to point throughout the model, including its boundary and interior, subject to some given constraints (design, manufacturing, etc.). Throughout this document, the term “material feature” will be used to denote a point, boundary or region of a model at which material property values and/or rates are defined. It should be understood that a material feature may or may not be a subset of a solid object being modeled, and it may merely be defined because it provides a convenient means for defining material distribution throughout the object. For example, a material feature might be defined which is not a part of the object being modeled, but which is part of an adjacent hypothetical object.

To illustrate what is meant by “material feature” and “material function,” consider the hypothetical example of a model of a diamond cutting head having a SiC base, an opposing diamond chip head, and an intermediate shank made of a functionally graded composition of SiC and diamond. The model has two material features (the diamond chip and the SiC base), and if one wishes to define the composition of the shank, one may construct two material functions (one for SiC and another one for diamond) which define composition along the shank. The material functions are (or may be) subject to additional constraints, such as the constraint that the fractions of each material must add to 1 at all locations along the shank (a constraint which is physically mandatory for an accurate model); the constraint that the properties must vary continuously along the shank; the constraint that the properties vary in accordance with some predefined relationship (e.g., linear variation from tip to base, or some algebraic, differential, integral, or other mathematical relationship); etc.

Thus, the goal is to develop a functional model which corresponds to the geometric model of the object, and which fits a number of material functions to material features in such a way that the material functions meet desired constraints, and smoothly parameterize the interior of the object. Such modeling is conventionally done via some form of spatial discretization of the interior of the object's model, such as mesh-based, finite-element based, voxel-based, set-based, and layer-based schemes. Such discretizations amount to conversions between the geometric and functional domains that are expensive to compute, and that lead to many complications. Initially, discretization methods introduce errors because they must approximate the geometry of objects and material features. Secondly, the ability to satisfy the constraints and to assure smoothness of properties places substantial restrictions on the types of allowed discretization methods. Thirdly, modifications to the model become extremely difficult since every change may require recomputing both the discretization and the definition of the model's material properties and/or how they vary; for example, merging two discretized elements with differently-defined material properties requires redefinition of the material properties in the newly-merged element. Finally, discretized representations are awkward for data exchange and standardization due to errors, approximations, and large size. Thus, it would be useful to have modeling methods which do not rely solely on discretization.

B. Distance Functions and Distance Fields

The modeling methods of the invention rely on distance functions, a class of mathematical functions which, as their name implies, define a value at one point in accordance with that point's distance from another point. As a more robust definition, it can be said that for any closed set S in Euclidean space, the function u: E³→R is the (Euclidean) distance function if it associates with any point p in space a non-negative real number equal to the Euclidean distance from p to S. In other words, for each pointset S, the distance function defines a scalar distance field. Several properties of distance functions and fields are well known:

PROPERTY (1): A point p belongs to the set S if and only if u(p)=0, which means that the distance field defines S implicitly. The description applies uniformly to all closed sets irrespective of their geometric, analytic, and topological properties, because these properties are all encoded within the distance function. This property provides a simple (yet powerful) representation scheme for all closed subsets of Euclidean space.

PROPERTY (2): For every value a of distance function u, u⁻¹(a) is a non-empty subset of E³. In other words, the distance provides a natural parameterization of the whole space by a single parameter: the distance to the set S. This property allows a simple method for extending properties of the set to the whole space (i.e., a material function defined for a material feature can be extended to the space about the material feature if the material function is a distance function).

PROPERTY (3): The distance function u is not differentiable at the points on the boundary of S and at those points that are equidistant from two or more points of S. At all other points p, u is differentiable with |∇u(p)∇=1 and with all higher derivatives at p vanishing in the direction of the gradient. This property assures that if properties of a set S are extended to the surrounding space (as discussed above for property (2)), this extension takes place in a gradual and predictable fashion.

As an added benefit, modeling properties with distance functions (i.e., using distance functions to define material functions) is somewhat intuitive: for many objects (and their models), the concept of properties varying in accordance with their distance from some feature is readily understandable. However, modeling with distance functions is not entirely free of difficulties, the most notable of which are computational cost and loss of differentiability at equidistant points. Regarding computational cost, when a set S is represented using n geometric primitives, it is reasonable to expect that the distance from a point p to S should be computable in O(n), or even O(log n) if S is represented using some hierarchical structure. Unfortunately, as discussed in (for example) M. E. Mortensen, Geometric Modeling (John Wiley and Sons, New York, 1985), computing the distance from p to a single geometric primitive (typically a curve or surface) usually requires a numerical iterative procedure, which is computationally burdensome. Regarding loss of differentiability, this may undermine some computational techniques and may not be acceptable in many engineering applications. As an example, in the context of material modeling, the lack of smoothness in a material function constructed as a function of distance can result in undesirable singularities, such as stress concentrations. These limitations would seem to make distance functions (and their distance fields) a poor choice for modeling of material properties.

C. Approximated (Normalized) Distance Fields

To overcome the aforementioned problems with exact distance fields may be overcome by replacing them with various smooth approximations, while preserving most of the attractive properties of the distance fields. In particular, the exact distance fields can be replaced with their m-th order approximations having the following characteristics. Suppose point p is a point on the boundary of set S, and v is a unit vector pointing away from S towards some points that are closer to p than to any other point in S. In other words, v coincides with the unit normal on smooth points of the boundary, but the notion of the normal direction is also well defined at sharp corners. A suitable m-th order approximation of u is a function (o that is obtained by requiring that only some of the higher order derivatives vanish, such that for all points p on the boundary of S:

$$\frac{\partial ω}{\partial v} = 1 ; \frac{{\partial }^{k} ω}{\partial {v}^{k}} = 0 ; k = 2 , 3 , … , m \qquad ( 1 )$$

Such a function ω is called normalized to the m-th order. Normalized functions behave like a distance function near its zero set (corresponding to the boundary of set S) and tend to smoothly approximate the distance function away from S. However, normalization is a local property and cannot guarantee that the function behaves as the distance function away from the boundary points. A higher order of normalization will imply better approximation of the exact distance field, particularly near the boundary of S. Thus, in short, normalized distance fields inherit most of the attractive characteristics of the exact distance field—they are also smooth (differentiable) on all points away from the boundary—but the accuracy of approximation deteriorates with the distance from the point set of interest.

Normalized distance fields can be constructed for virtually all geometric objects of interest in engineering, and may be constructed by a variety of methods (see, e.g., A. Biswas and V. Shapiro, Approximate Distance Fields with Non-Vanishing Gradients, Graphical Models, Vol. 66, Issue 3 (May 2004), Pp. 133-159; V. Shapiro and I. Tsukanov, Implicit functions with guaranteed differential properties, Fifth ACM Symposium on Solid Modeling and Applications, Ann Arbor, Mich., 1999; and references noted therein). Thus, the remainder of this document will assume that a distance field can be constructed for any material feature. Further, throughout the remainder of this document, the term “distance field” will refer to any normalized distance field.

D. Material Property Modeling—Single Material Feature

The simplest problem in material modeling involves a single material feature—a closed subset S with known material properties. S may take any geometry, topology, or dimension, and it may be a subset of a known object, a part of an object yet to be designed, or an auxiliary geometry used as a reference datum for defining material distribution throughout an object. Further, it may be the only material feature, or as will be discussed later in this document, it may be one of several material features relating to an object. Following the foregoing discussion, it is assumed that a normalized distance field u can be defined or derived for S, and that the material properties of S can be set forth in the form of a material function F₀(p), pεS. As will be discussed below, any influence of such a material feature may be extended and controlled throughout the space using distance to the material feature as a parameter.

D(1). Material Property Modeling—Single Material Feature: the Distance Canonical Form

In order to understand how material properties may be controlled in terms of distance, assume that a desired material function F(u, x, y, z) is already defined for the feature S. (In general, F may also depend on parameters in addition to spatial coordinates.) Consider the behavior of F as a function of distance u, while keeping all other variables fixed. By definition, for all points p of the boundary of material feature ∂S, F(u(p))=F(0) must be equal to the material conditions prescribed on S. As point p moves some distance away from the boundary of the feature S, we can express the value of F(p) in terms of values and derivatives of F(0) using the Taylor series expansion:

$$F ( u ) = {F}_{0} ( 0 ) + {uF}_{1} ( 0 ) + {\sum }_{k = 2}^{m} \frac{1}{k !} {F}_{k} ( 0 ) {u}^{k} + {u}^{m + 1} Φ \qquad ( 2 )$$

This representation, which will be referred to as the distance canonical form for a material function, is a straightforward generalization of the classical Taylor series, where the term |x−x₀|, measuring the distance to point x₀, is replaced by u, measuring the distance to a set of points S. Thus, expression (2) is a representation of any function F(u) as a polynomial in u of order m plus the remainder term u^{m+1} Φ. The coefficients Fₖ in the classical Taylor series are kth order derivatives of function F with F₀=F(x₀).

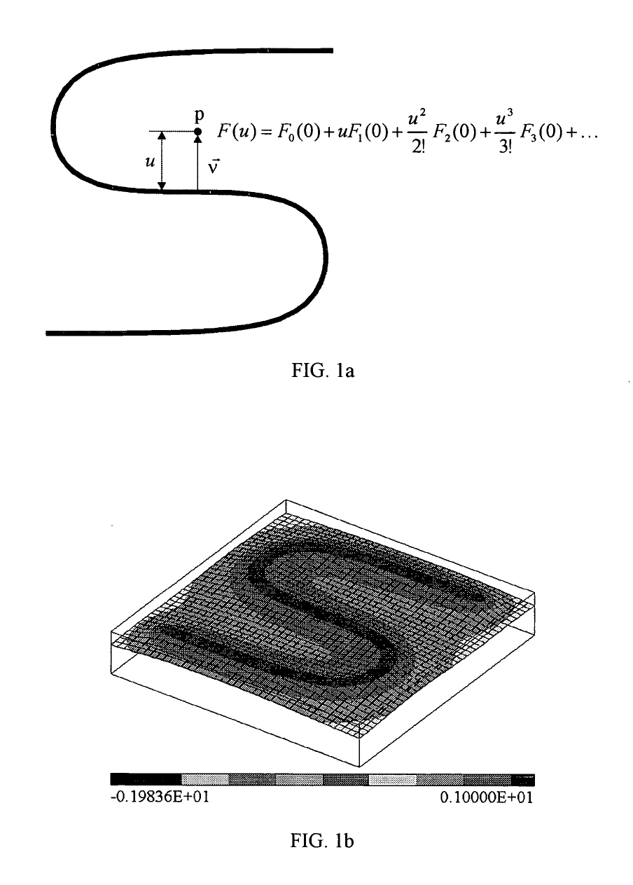

FIGS. 1(a) and 1(b) provide an illustration, wherein FIG. 1(a) illustrates a material function F defined about an S-curve, with the material function being represented by a Taylor series expansion in the powers of the distance field u. If the change is measured in the normal direction v, and if the distance field u is normalized to mth order, then the corresponding Taylor coefficient Fₖ is kth partial derivative of F in the direction v normal to the boundary of the material feature, with F₀(0)=F(0). All coefficients Fₖ(0) are evaluated on the boundary of S where u=0, and F₀(0) must coincide with the prescribed material distribution f(p) on the boundary of the feature. FIG. 1(b) then displays the value of an exemplary material function F(u)=e^{(-1.5)u} in terms of the distance u to the S-curve.

Then consider that the classical Weierstrass theorem states that any continuous function can be approximated as closely as desired by a polynomial function. This implies that any continuous material function may be approximated by a distance polynomial in u as closely as desired. Applying this to the distance canonical form of expression (2), this means that the coefficients of individual terms of the distance canonical form can be selected and controlled to represent a material function, wherein the representation satisfies given design, analysis, manufacturing, or other constraints.

D(2). Material Property Modeling—Single Material Feature: Explicitly Defined Material Functions

The literature shows that material functions have been described explicitly as functions of distance, based on experimental data or analytical studies; examples are shown in S. Bhashyam, K. H. Shin, and D. Dutta, An integrated CAD system for design of heterogeneous objects, Rapid Prototyping Journal, 6(2): 119-135 (2000), and Yoshinari Miyamoto, W. A. Kaysser, and B. H. Rabin (eds.), Functionally Graded Materials: Design, Processing and Applications, Kluwer Academic Publishers, Boston (1999). Any such material function of distance may be put in the distance canonical form of expression (2) by straightforward repeated differentiation with respect to the distance variable. For example, using the material function of F(u)=e^{-1.5u} (as in FIG. 1(b)), the first four terms of the corresponding distance canonical form are obtained by straightforward application of expression (2) as

$$F ( u ) = {ⅇ}^{- 1.5 u} = 1 - 1.5 u + \frac{{( - 1.5 )}^{2}}{2 !} {u}^{2} + \frac{{( - 1.5 )}^{3}}{3 !} {u}^{3} + {u}^{4} Φ$$

where the last term is the unknown O(u⁴) remainder term. Each of these four terms is a function of u^{k} (k=0, 1, 2, 3). As further terms are added (as k→∞), the series approaches the original function F(u)=e^{-1.5u}. However, in practical situations, only a small number of terms may be needed for an accurate representation of the material function.

Recall that the coefficients of the power terms in the distance canonical form correspond to the derivatives of F(u) in the direction v normal to the boundary of the feature S. For example, in the canonical form of the exponential function F above, the value of F on the boundary is F₀₌₁, the first derivative in the normal direction is F₁=−1.5, the second derivative F₂=(−1.5)² and so on. This suggests a general method for specifying and controlling an arbitrary material function in terms of its behavior on the boundary of the material feature, namely by the values of the material function and its derivatives up to desired order in the direction of the outward normal to the boundary. When these values are constants, syntactic substitution into the distance canonical form yields the desired material function.

In some applications, it may be desirable to vary both the material function and its normal derivatives throughout the material feature. Suppose F₀=F₀(p) is a given material distribution on the feature S and its normal derivatives are prescribed on the boundary of S as Fₖ=Fₖ(p). One might be tempted to construct the material function as

$$F ( u ) = {F}_{0} ( p ) + {F}_{1} ( p ) u + \frac{1}{2} {F}_{2} ( p ) {u}^{2} + \frac{1}{6} {F}_{3} ( p ) {u}^{3} + … + {u}^{m + 1} Φ \qquad ( 3 )$$

but this could be incorrect. For example, the first derivative of F(u) at u=0 yields

$$\frac{\partial {F}_{0} ( p )}{\partial 𝓋} + {F}_{1} ( p ) ,$$

which is equal to F₁ only if

$$\frac{\partial {F}_{0}}{\partial 𝓋} = 0.$$

Similarly, for F₁(p) to qualify as the second coefficient in the canonical form, its derivatives in the normal direction must vanish or they will affect the values of the higher order terms in the canonical form. In other words, for the expression (3) to qualify as the distance canonical form (2), the coefficient of each term has to behave as a constant in the direction v normal to the boundary. Formally, these conditions may be identified as:

$$\frac{{\partial }^{1} {F}_{k} ( p )}{\partial {𝓋}^{1}} {\vert}_{u = 0} = 0 , ( l = 1 , 2 , … , m - k ) \qquad ( 4 )$$

This requirement may appear to severely limit which functions may be prescribed by users or applications on the boundary of material features to serve as coefficients in the distance canonical form. Fortunately, every function Fₖ(p) may be “conditioned” to satisfy the requirement (4) using a simple coordinate transformation F*ₖ(q) Fₖ(p−u∇u). If u is a normalized distance field, then in the neighborhood of the boundary, the conditioned function F*ₖ(q) returns the value of Fₖ at the closest point (p) on the boundary of the material feature. This implies that Fₖ and F*ₖ have the same values on the boundary of the feature and that F*ₖ behaves as constant in the neighborhood of the boundary in the normal direction v. Additional details and examples, including a method to incorporate other types of directional derivatives, can be found in V. L. Rvachev, T. I. Sheiko, V. Shapiro, and I. Tsukanov, Transfinite interpolation over implicitly defined sets, Computer Aided Geometric Design, 18:195-220 (2001).
D(3). Material Property Modeling—Single Material Feature: Implicitly Defined Material Functions (Constrained Material Functions)

Explicit control of material properties may not be adequate for a number of reasons. Material distributions may not be specified in the closed form because they usually must follow complex physical laws and constraints for which closed form solutions are not available. The distance canonical form, and the associated explicit power series, provide only an approximation to a material distribution with at least three distinct sources of errors. Initially, by definition, as a Taylor series expansion, the distance canonical form represents the function locally (near the boundary of the material feature). Secondly, explicit representation only approximates the material function when the remainder term of expression (2) is omitted. Finally, the accuracy of the distance canonical form depends on the accuracy of the distance field. Where normalized (approximate) distance fields are used in order to assure differential properties, the accuracy of approximation may degrade substantially away from the feature.

Because the distance canonical form (2) applies to any and all functions, the remainder term may always be chosen to make the foregoing inaccuracies arbitrarily small or to eliminate them altogether. The errors are measured against one or more constraints on the material function specified either by the user or an application. Such constraints could be local or global, and may include algebraic, differential, or integral conditions that implicitly define the material function. For most such constraints, the remainder term cannot be determined exactly. It is therefore useful to represent the unknown function Φ in the remainder term u^{m+1} Φ (by a linear combination

$$Φ = {\sum }_{i = 1}^{n} {C}_{i} {X}_{i} \qquad ( 5 )$$

of known basis functions Xᵢ from some sufficiently complete space, such as polynomials, B-splines, trigonometric polynomials, etc. Both errors and the basis functions Xᵢ are functions of spatial variables, and all modeling problems reduce to determination of the unknown coefficients C, that satisfy the prescribed constraints on the material function either exactly or approximately.

Assume a material function F(u) is to be constrained to behave as some continuous function f(p) on points p away from the material feature. F(u) already satisfies the material behavior on the feature; hence, the problem becomes one of minimizing the difference between F(u) and f(p) globally. The difference can be measured many different ways, for example, using the standard technique of least squares. In this case, the task is to minimize the integral

$${\int }_{Q} {( F ( u ) - f ( p ) )}^{2} ⅆ Ω = {\int }_{Q} {( {F}_{0} ( u ) + {uF}_{1} ( u ) + … + {u}^{m + 1} {\sum }_{i = 1}^{n} {C}_{i} {X}_{i} ( p ) - f ( p ) )}^{2} ⅆ Ω \qquad ( 6 )$$

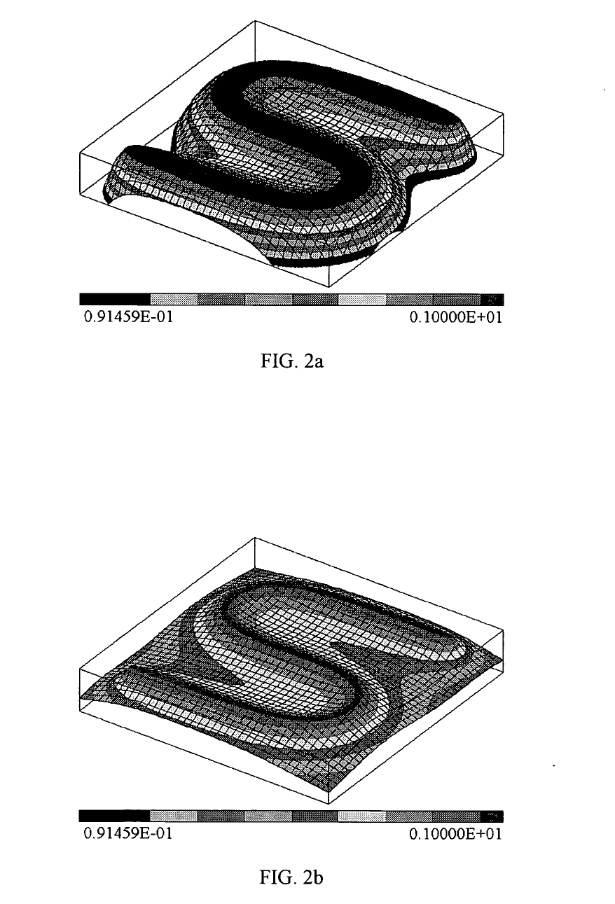

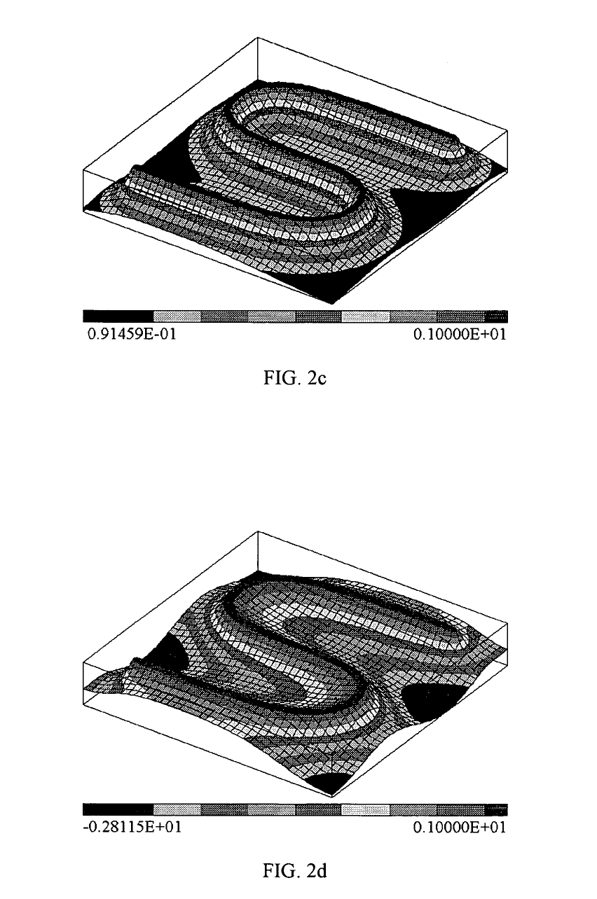

For a specific example, suppose a material function is defined explicitly as F(u)=1−u² on an S-shaped curve (see FIG. 2(a)). As distance u increases, F(u) quickly drops to 0 and then turns negative, which may not be desirable for some material properties. In order to keep the material function positive, the global constraint that F(u) must approximate the behavior of

$$f ( p ) = 1 - \frac{u}{1 + u}$$

globally can be imposed. This function for the S-curve is shown in FIG. 2(b). To compute the least square fit of F(u) to f(p), the functions {Xᵢ} can be chosen to be a set of bi-cubic B-splines on a uniform Cartesian 81×81 grid. As shown in FIG. 2(c), the resulting function combines the benefits of the parabolic distribution near the S-curve feature and maintains positive values everywhere in space.

The problem of constructing a material function given its values and derivatives on some point sets may be viewed as a problem of surface fitting, where the surface is really a material function. Thus, the differential and integral constraints used in computer-aided geometric design of surfaces (as described in J. Hoscheck and D. Lasser, Fundamentals of Computer Aided Geometric Design, A K Peters (1993); Nikolas S. Sapidis, editor, Designing Fair Curves and Surfaces, SIAM (1994); V. L. Rvachev, T. I. Sheiko, V. Shapiro, and I. Tsukanov, Transfinite interpolation over implicitly defined sets, Computer Aided Geometric Design, 18:195-220 (2001)) may be handled in a similar manner using variational or other numerical methods. For instance, suppose it is desired to choose the remainder term so that F(u) satisfies the differential constraint ∇F(u)=f(p). This means that the coefficients Cᵢ of the basis functions that minimize the functional ∫_{Ω}(∇F(u)−f(p))² dΩ must be determined. FIG. 2(d) shows the result computed using the least squares method for f(p)=−2 on the same 81×81 grid of bi-cubic B-spines. Note that the scale in FIG. 2(d) is different from FIGS. 2(a) and 2(b) and clearly shows that F(u) turns negative away from the material feature.

The foregoing examples are also indicative of the computational machinery that is required for enforcing the constraints: differentiating the functions under the integral signs with respect to the unknown coefficients Cᵢ, integrating them over the domain (usually represented by a geometric model), and using the integrals to assemble a system of algebraic (often linear) equations in Cᵢ. Solving for Cᵢ and substituting

$${\sum }_{i = 1}^{n} {C}_{i} {X}_{i}$$

for Φ in the distance canonical form (2) gives the desired material function. In contrast to mesh-based methods, this approach does not require spatially conforming discretization. By construction, the distance canonical form (2) satisfies all prescribed material conditions on the material feature exactly. Integration and visualization over the object may or may not require spatial discretization, depending on the basis functions and sampling method, but a conforming discretization is never required. In the context of material modeling, this independence of material representation from any particular mesh or spatial discretization, allows seamless integration of geometric and material modeling with effortless changes and intuitive control.

One potential disadvantage of the distance-based method is that the constructed functions depend on the distance field of the material feature and hence are not known a priori. This means that differentiation of such functions must be performed at run time at some computational cost.

E. Material Property Modeling of Multiple Features

A more typical modeling situation involves the need to model a heterogeneous object having several material features Sᵢ(i=1, . . . , n) with known but distinct material characteristics. In this case, individual material functions Pⁱ can be constructed for each material feature by use of the material value P₀ⁱ, derivative information {Pₖⁱ} on the ith feature Sᵢ, and the distance canonical form and techniques of the last section. As demonstrated below, these individual material functions Pⁱ may then be combined into a single material function p^{Comb} (P¹, P¹, . . . , P^{Ω}), in a meshfree manner, while preserving the exactness, completeness, and intuitiveness of the distance-based representation scheme.

There are many different ways to “combine” individual material functions, but for an accurate representation, it is desirable that the combination preserve the values and derivatives specified on each material feature (i.e., P^{comb} should preserve the values and derivatives of Pᵢ on every material feature Sᵢ). When the features Sᵢ are sets of points (curves, surfaces, solids)—which will generally be the case when an object is being modeled on a CAD system or the like—transfinite interpolation is the recommended mode of combination. Using transfinite interpolation, P^{Comb} can be expressed as:

$${P}^{Comb} ( p ) = {\sum }_{i = 1}^{n} {P}^{i} ( p ) {W}_{i} ( p ) , i = 1 , … , n \qquad ( 7 )$$

wherein each Wᵢ is a weight function controlling the influence of the material function Pⁱ associated with feature Sᵢ (i.e., the weight Wᵢ defines the contribution of the material function Pⁱ associated with a material feature Sᵢ). The weight functions Wᵢ can be defined in numerous ways, but it is preferred that they have the following properties:
(1) For points on the ith material feature Sᵢ, P^{Comb}(p)=Pⁱ(p), and thus each Wⁱ(p) should be identically 1 on points pεSᵢ and should be identically 0 for points pεSⱼ, j≠i (i.e., for points on the other material features.)
(2) Completeness of the interpolation method in terms of its ability to reproduce constants and polynomials requires that the weight functions Wᵢ(p) form a partition of unity, i.e., that

$${\sum }_{i = 1}^{n} {W}_{i} ( p ) = 1 , 0 \leq {W}_{i} ( p ) \leq 1.$$

(3) The weight functions Wᵢ should be as smooth as needed to assure the smoothness of properties of the combined function P^{Comb}.

(4) The weights (and their control over the influence of individual material features relative to each other) preferably have intuitive meaning. More generally, it is preferred that the interpolation method not require spatial discretization of the domain, and it should accommodate material features Sᵢ of arbitrary shape, topology, and dimension.

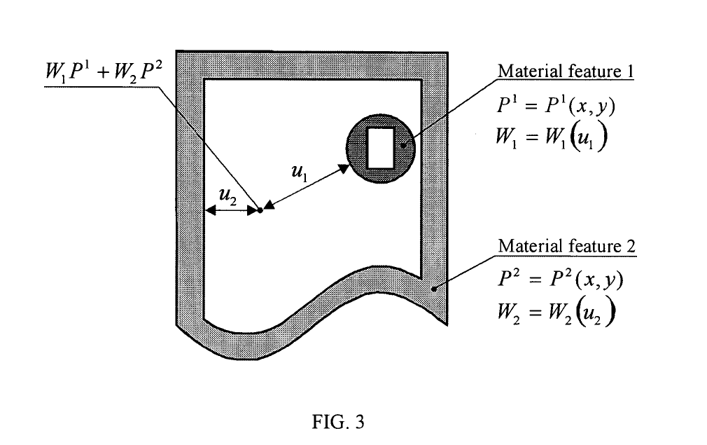

Pursuant to these principles, a recommended method is to design the weight function Wᵢ(p) based on the distance from p to the source feature Sᵢ that is responsible for the material function Pⁱ. This relationship is illustrated in FIG. 3, wherein two material features S₁ and S₂ of a modeled object are illustrated, with the material features having respective material functions P¹ and P² and their combination being determined in accordance with weights W₁(p) and W₂(p). Developing this concept further, the weight function W₁(p) can be designed such that if the distance u₁(p) from material feature S₁ is greater than the distance u₂(p) from material feature S₂, then Wᵢ(p)<W₂(p) (which seems intuitive, since S₁ should also have a smaller influence than S₂ at point p). A particularly preferred approach is to use inverse distance weighting, wherein the weight Wᵢ(p) is set inversely proportional to some power of distance uᵢ^{k}(p). Normalizing by the sum of all weights so that each weight function varies between 0 and 1 then yields:

$${W}_{i} ( p ) = \frac{{u}_{i}^{- k} ( p )}{{\sum }_{j = 1}^{n} {u}_{j}^{- k} ( p )} = \frac{{\prod }_{j = 1 ; j \neq i}^{n} {u}_{j}^{k} ( p )}{{\sum }_{j = 1}^{n} {\prod }_{j = 1 ; j \neq i}^{n} {u}_{j}^{k} ( p )} \qquad ( 8 )$$

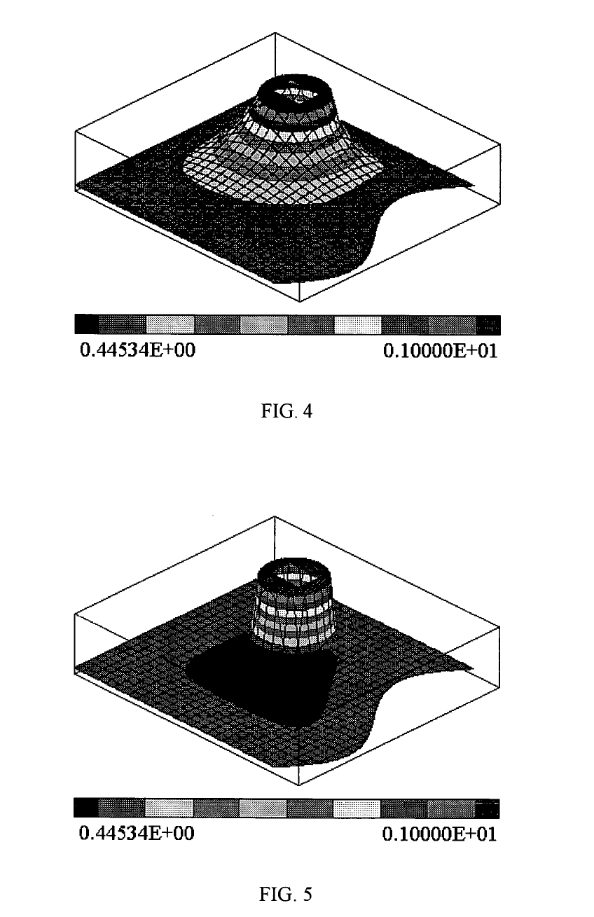

In the inverse distance weighting (or inverse distance interpolation) expression (8), it can be seen that the weights Wᵢ(p), i=1, . . . , n meet all of the aforementioned preferred traits. The last expression on the right provides an equivalent but numerically more stable form. FIG. 4 shows inverse distance interpolation for the problem in FIG. 3 with P¹=1, p²=0.5e^{-u}^{₂}_{₂}, first-order normalized distance fields, and k=1.

The exponent k of the term uᵢ^{k} controls the smoothness of the function on the points of the material feature Sᵢ where uᵢ(p)=0. In particular, the power k should exceed the highest power of the term k in the canonical distance form (2) for the material function Pⁱ. In general terms, P^{Comb} and Pⁱ have the same values of derivatives in any direction up to the order k−1 at the i-th feature, and this property does not depend on how Pⁱ was constructed. The inverse distance weighting expression (8) can also accommodate different exponents (and smoothness) for each material feature by replacing terms uₖⁱ with uᵢ^{k}.

Inverse distance weighting is preferred because it is simple and intuitive; for example, when k₁=k₂₌₁, the inverse distance weights Wᵢ for two material features are respectively W₁=u₂/(u₁+u₂) and W₂=u₁/(u₁+u₂). When the features are isolated points and uᵢ are exact distances W_{1 and W}₂ are the barycentric coordinates of the line segment through the points. For arbitrary material features, these weights implement linear interpolation between the material functions on individual features.

The inverse distance weighting is only one of many possible ways to construct the weight functions Wᵢ. A more general method for constructing the weight functions associates an influence function wᵢ(p) with each material feature. Then each weight function Wᵢ of the material feature Sᵢ is simply the normalized influence function

$${W}_{i} ( p ) = \frac{{w}_{i} ( p )}{{\sum }_{j = 1}^{n} {w}_{j} ( p )} \qquad ( 9 )$$

Note that if the influence functions are in the distance-dependent form wᵢ=uᵢ−k in expression (9), the expression is the same as the inverse distance weighting expression (8).

Other choices of influence functions naturally result in other weightings for the material functions P. However, not all choices are necessarily appropriate, and recommended influence functions wᵢ are those which are expressed in terms of distance. To illustrate, if all influence functions are set wᵢ(p)=1, i=1, 2, . . . , n (a non-distance dependent function), then the weight functions become Wᵢ=1/n and the linear combination (7) of material functions becomes a weighted average of the individual material functions Pⁱ. Note that here the weight functions do not form a partition of unity (which, as described above, is a preferred property of weight functions).

Another useful influence function is wᵢ(p)=(λᵢ(uᵢ)uᵢ)−k, with λᵢ>0. This provides another weighted inverse distance method, with more precise control of how the influence of a particular feature Sᵢ diminishes with increase in distance uᵢ. The influence coefficients λᵢ; can take a wide variety of forms, such as exponential functions, polynomials with local support, cubic splines, and trigonometric functions. This influence function results in weight functions Wᵢ(p) which meet all of the aforementioned requirements (i.e., Wᵢ(p)=δᵢⱼ, {Wᵢ(p)} form the partition of unity, and Wᵢ(p) is differentiable up to the order k−1 at the material feature Sᵢ and interpolates derivatives of specified Pᵢ up to the order k−1). To illustrate, FIG. 5 shows the results of weighted transfinite inverse distance interpolation for the two material features of FIG. 3 using influence functions λ₁=e^{60w}^{_{i and λ}}₂₌₁. The influence zone of material feature 1 is diminished substantially in comparison to its influence zone in FIG. 4 where λ₁=λ_{2=1.}

The foregoing discussion of transfinite interpolation methods made no assumptions on the form of material functions Pⁱ associated with individual features. The material functions Pⁱ can be represented as known functions of the distance field Pᵢ(uⁱ); of spatial variables Pᵢ(x, y, z); by the canonical distance form (with or without the remainder term), explicitly or implicitly; or in other forms. In all cases, the transfinite interpolation method provides explicit means for combining the material functions into a single global function P^{Comb}(p). This means that in addition to possible inaccuracies in individual Pᵢ, the transfinite interpolation itself has a limited precision for the reasons discussed in the foregoing section D(3). However, the constructed interpolating function P^{Comb}(P¹, P², . . . , P^{Ω}) may be adjusted to satisfy a variety of additional constraints. Without loss of generality, let Pⁱ be represented by the first mᵢ terms of the distance canonical form (2), and P^{Comb} is a transfinite interpolation (7) of Pⁱ, i=1, . . . , n. It can be shown that representation in the form

$$F = {P}^{Comb} + Φ {\prod }_{i = 1}^{n} {u}_{i}^{{m}_{i}} \qquad ( 10 )$$

is complete in the sense of Weierstrass theorem, and therefore includes every admissible material function. The second term is essentially a product of the remainder terms for each individual material function Pⁱ. The power mᵢ of uᵢ indicates that derivatives up to order mᵢ−1 have been satisfied on the ith material feature. The unknown function Φ can be represented by a linear combination of basis functions (as in expression (5)) with coefficients Cᵢ chosen to satisfy the desired constraints.
F. Vector Valued Material Properties

The foregoing approaches to material modeling extend directly to a more general case where a material property is a vector-valued function. Common examples of such properties include material anisotropic grain orientation represented by a vector field; material composition represented by a vector of volume fractions; and microstructure models wherein vectors represent varying shape inclusion parameters. In all cases, the vector valued material function F:E³→M where M is usually an application specific manifold. Locally every manifold can be viewed as a copy of Rⁿ, and we can consider F(p) to consist of a finite number of scalar component material functions (U(p), V(p), W(p), . . . ).

Each scalar component function can be treated independently using the techniques discussed previously, but the component functions are also constrained by the manifold M. For example, when F represents orientation of the material grain, F(p) must be a unit vector at every point pεE³. When F represents a composition of several materials, each component function models a fraction of the total volume, and the sum of all components must be equal to 1 at every point of space. Many other and multiple constraints are possible depending on the properties of the manifold space M.

A general approach to modeling a vector material function with n components subject to k constraints is to construct n−k components separately and then use the constraints to solve for the remaining k component functions. For example, if F(p)=(U(p), V(p),W(p)) is a unit vector function, we can construct U(p) and V(p) to be sufficiently smooth functions with values in the range (−1, 1) and define W(p)² to satisfy 1−U(p)²−V(p)². On the other hand, if U(p) and V(p) are volume fractions used in material composition, then we can define the third fraction as W(p)=1−U(p)−V(p) in order to enforce the constraint. There are two potential difficulties with this approach.

First, the problem of existence: even when the solution to the constrained problem exists, it may be difficult to compute, and it may be invalidated if the component functions are constructed separately without additional constraints. It does not make sense to impose the unit vector constraint if one of the component functions exceeds the value of 1.

Second, the problem of uniqueness: in general, there is no reason to expect that the above method of construction of F is unique. In the case of material composition modeling, if we construct V(p) and W(p) first, there is no reason to expect that U(p)=1−V(p)−W(p) is the same component function that would result if U(p) was modeled directly first.

Material modeling techniques that do not guarantee existence and uniqueness of the solution are of questionable value, because they are not likely to reflect realistic physical conditions. Further, these issues have to be resolved in the context of specific applications. When a vector function F(p) is a solution of a boundary value problem, its existence and uniqueness follow directly from the classical conditions on well-posed problems (as shown in, e.g., Richard Courant and David Hilbert, Methods of Mathematical Physics, Wiley, New York (1989)). In this case, F(p) can be constructed by approximating the (vector-valued) remainder term in the distance canonical form using the meshfree techniques described previously. The same theoretical results also guarantee the completeness of the solution.

In other cases, general conditions can be defined for existence and uniqueness of material property modeling using normalized distance fields. Consider the material volume of an object composed from m different materials. The fraction of each material at every point p of the object is represented by a scalar material component function P^{Comb,j}(p), j=1, 2, . . . , m. In other words, the challenge is to construct a vector valued material function with the constraint that its scalar components must form a partition of unity:

$$P ( p ) = ( {P}^{Comb , 1} , {P}^{Comb , 2} , … , {P}^{Comb , m} ) such that {\sum }_{j = 1}^{m} {P}^{Comb , j} = 1 \qquad ( 11 )$$

Each jth material function P^{Comb, j}(p) must interpolate the material functions P^{i,j}=1, 2, . . . , n associated with n material features of the object using some weight functions Wᵢ. If each scalar component function P^{Comb, j} is constructed separately, then satisfying the partition of unity constraints appears non-trivial in general. It can be shown that when the weights Wᵢ satisfy the conditions set forth in the foregoing section E, the interpolated scalar component functions preserve the partition of unity property if it is satisfied by the individual feature functions P^{i,j}. First, let P^{i,j}≧0 be the jth material fraction function associated with the ith feature, and let the material fraction function P^{Comb, j} be constructed as a convex combination of {P^{i,j}} with the same weights Wᵢ for every feature as:

$$\begin{matrix}{P}^{Comb , j} = {\sum }_{i = 1}^{n} {P}^{i , j} {W}_{i} , j = 1 , 2 , … , m \\ Then , \\ {\sum }_{j = 1}^{m} {P}^{Comb , j = 1} = 1 if {\sum }_{j = 1}^{m} {P}^{i , j} = 1\end{matrix}$$

This follows from the straightforward application of the definitions of the weighted interpolation and the requirement that the weights themselves form a partition of unity. Then summing all global m material fraction functions:

$${\sum }_{j = 1}^{m} {P}^{Comb , j} = {\sum }_{j = 1}^{m} {\sum }_{i = 1}^{n} {P}^{i , j} {W}_{i} = {\sum }_{i = 1}^{n} ( {\sum }_{j = 1}^{m} {P}^{i , j} ) {W}_{i} = {\sum }_{i = 1}^{n} {W}_{i} = 1$$

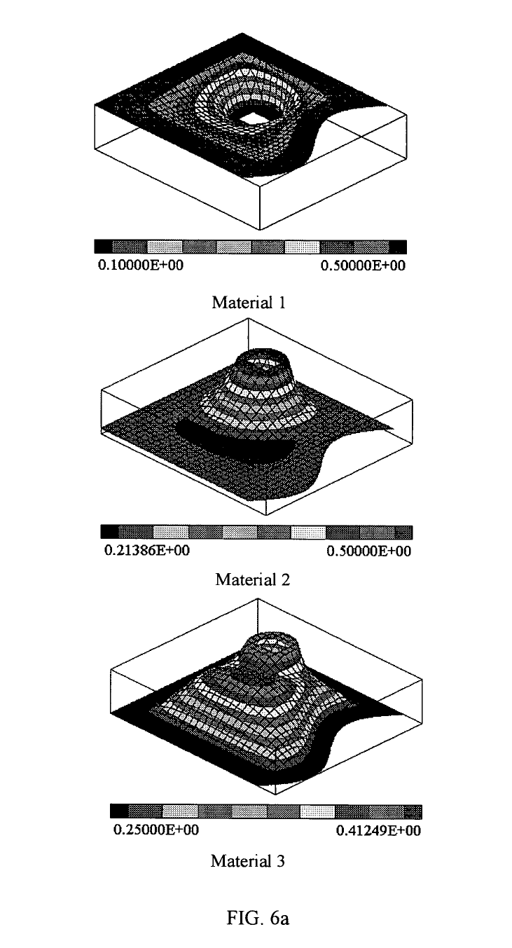

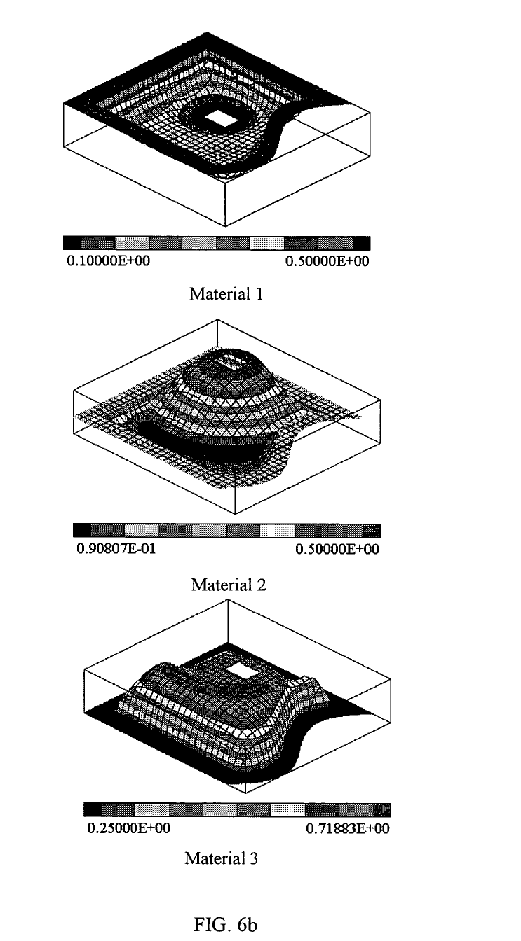

The practical consequence is a broad applicability of the proposed approach to material composition modeling. An example is shown in FIGS. 6(a) and 6(b), where a composition of three materials is defined over the two dimensional shape of FIG. 3, which has two material features. For each feature, three distinct material fraction functions are constructed using the techniques of the foregoing section D, making sure that these functions form a partition of unity:
Feature 1 material fraction functions:
p^{1.1}=0.5e^{-u}^{₂}^{^{2; p}}^{2.1}=0.25; p^{3.1}=1−p^{1.1}−p^{2.1}
Feature 2 material fraction functions:
p^{1.2}=0.1(1−0u₂²); p^{2.2}=0.5e−u^{₂}^{^{2; p}}^{3.2}=1−p^{1.2}−p^{2,2}

FIG. 6(a) shows the result of inverse distance interpolation between the two features, applied to each of the three materials. FIGS. 6(b) shows another interpolation, this time with different influence coefficients prescribed on each feature:

$${λ}_{1} = \text{(} 0.1 + 10 {ⅇ}^{- 5 {u}_{1}^{2}} \text{)} and {λ}_{2} = ( 0.5 + {ⅇ}^{\frac{- {u}_{2}^{2}}{2}} ) .$$

In all cases, the results do not depend on the order in which the functions are constructed, and the partition of unity condition is guaranteed by the foregoing conditions.

G. Construction of Working Applications

It is expected that the invention will have greatest applicability as a feature of a conventional solid modeling program (e.g., to a CAD program). Conventional CAD systems tend to focus on construction of geometric models, and on computerized behavior analysis of these models (e.g., stress/strain analysis) under the assumption of homogeneous material properties. The invention can allow such CAD systems to provide the same functionality, but with their capabilities extended to handle heterogeneous materials. The CAD system might then be used to define the geometric model and specify material properties at (material) features of the model. The invention can then utilize this input to generate (either automatically or with user guidance) distance fields, and use them in accordance with the foregoing discussion to construct material functions which define material properties elsewhere on the model.

The distance fields are possibly most easily generated by explicit construction: by treating the distance field for an overall geometric model as the union of the distance fields of its individual parts. Explicit construction of distance fields is relatively straightforward for most CAD models, wherein users construct geometric models from stock sets of geometric primitives (stock polygons, curves, solids, etc.). It is known from U.S. Pat. No. 6,718,291 to Shapiro et al. (which is incorporated by reference herein) that geometric models—such as CSG (Constructive Solid Geometry) and b-rep (Boundary Representation) models—are (or can be) defined as a combination of geometric primitives. Further, where the geometric primitives can each be modeled by an implicit function, the combination of the implicit functions of the primitives results in a representation of the overall model. In similar fashion, if a computerized geometric model can be defined as a combination of geometric primitives for which distance fields are known, the combined distance fields will represent the overall model. More generally, any given curve or surface can be defined as a union of individual segments (primitives), and if distance fields can be defined for each segment/primitive, then the individual distance fields can be combined into a single distance field. If the geometric model can be exactly decomposed into segments/primitives (i.e., if the geometric model can be exactly represented by the union of the segments/primitives), then the zero set of the constructed distance field will coincide exactly with the original geometric model; if approximations are needed (i.e., if certain segments/primitives do not exactly correspond to the geometric model), the constructed distance field will deviate from the original geometric model in parallel with the deviation of the approximation. Further, if the distance fields of the individual segments/primitives are normalized, the constructed distance field for the overall model will be normalized everywhere except at the joining points.

Distance fields could also or alternatively be directly generated by procedural methods, wherein numerical algorithms are used directly to calculate the distance fields from the geometric model in question. However, these procedural methods can be problematic owing to computational expense and failure of the calculated distance field(s) to meet desired analytic properties (such as smoothness and differentiability). Other exemplary methods include interpolation methods (see, e.g., Alon Raviv and Gershon Elber, Three dimensional freeform sculpting via zero sets of scalar trivariate functions, Proceedings of the fifth ACM symposium on Solid modeling and applications, ACM Press (1999), Pp. 246-257; P. Brunet, J. Esteve and A. Vinacua, Multiresolution for algebraic curves and surfaces using wavelets, Computer Graphics Forum, 20(1):47-58 (2001); Vladimir V. Savchenko, Alexander A. Pasko, Oleg G. Okunev, and Tosiyasu L. Kunii, Function representation of solids reconstructed from scattered surface points and contours, Computer Graphics Forum, 14(4):181-188 (1995); and Greg Turk and James F. O'Brien, Shape transformation using variational implicit functions, Proceedings of the 26th annual conference on Computer graphics and interactive techniques, ACM Press/Addison-Wesley Publishing Co. (1999), Pp. 335-342); level set methods (see, e.g., D. Breen, S. Mauch, and R. Whitaker, 3D scan conversion of CSG models into distance, closest-point and colour volumes, Volume Graphics, Springer, London (2000), Pp. 135-158); and potential functions (Narendra Ahuja and Jen-Hui Chuang, Shape representation using generalized potential field model, IEEE Transaction Pattern Analysis and Machine Intelligence, 19(2): 169-176 (February 1997)).

While the foregoing approaches are useful for standard CAD geometric models, the invention need not only be used with geometric models designed by a designer or machine; it is readily used with sampled real-world data as well. As an example, the invention might be used with a 2-D digital image of an object (e.g., a photo or X-ray), or a 3-D digital model of an object (e.g., from an MRI image), wherein data values of the pixels or voxels (the samples) are used to define the material features, their property values, and the distance functions about such material features. As an example, a computerized system can be easily trained to recognize certain features of an X-ray, such as the bone/tissue boundary and the skin/air boundary. Material property values can then be presumed for certain material features (e.g., for the bone and skin), with these values perhaps being dependent on the data values of the pixels of these features. For example, the pixel values corresponding to the bone might be assigned a particular density value, and the skin pixels might be assigned another density value. Distance fields can then be generated about these material features, and their combination (in conjunction with the assigned density values) may result in a material function which defines the density of the entire X-rayed object: at the bone, the skin, and the tissue therebetween. The resulting model may then be used in subsequent behavior analyses (e.g., in simulations or strength analysis), or the newly-defined property values can be analyzed for irregularities which may indicate disorders, etc. A discussion of methodologies for constructing distance fields from digital images can be found, for example, in Sarah F. Frisken, Ronald N. Perry, Alyn P. Rockwood, and Thouis R. Jones, Adaptively sampled distance fields: a general representation of shape for computer graphics, Proceedings of the 27th Annual Conference on Computer Graphics and Interactive Techniques, ACM Press/Addison-Wesley Publishing Co. (2000), Pp. 249-254.

The invention can possibly be most easily implemented as a stand-alone application which can receive input (such as geometric models) from other preexisting programs, and which can then define a material function for the model (and supply this as output to the preexisting programs, if desired). An example of a material modeling system of this nature might include the following components.

First, an interactive material modeling user interface can be provided to serve as a front end for the remaining modules described below. It can allow the user to select/construct the geometry of the geometric model and its features, and assign materials, relative weights (influences) of material features, desired gradients/rates of change for material properties, or other constraints. It can preferably also allow the user to specify matters which affect the underlying mathematical model (i.e., which affect the geometric model as it is represented in the geometric domain), such as the order of normalization used for the distance fields, any basis functions used for implicit definition of material functions, the type of interpolation to be used to construct the combined material function representing the geometric model overall, etc. The interface should allow the user to visualize the geometric/material model as it is being developed, with material distributions throughout the model perhaps being displayed by colors or other visualization methods.

Second, a geometric modeling kernel should be provided to efficiently represent (and optionally construct) geometric models, answer geometric modeling queries (including distance computations and the like, for use in the distance field computation module discussed below), and generate graphical output of the geometric/material model being designed. The Parasolid geometric modeling engine (UGS, Plano, Tex., USA) is preferred owing to its widespread use in most common CAD systems, thereby allowing interoperability between the material modeling system and the geometric outputs of most common CAD systems.

Third, a distance field computation module should be provided to compute or otherwise determine the distance fields for each of the material features (i.e., the material functions), so that the interpolation module (discussed below) can smoothly interpolate the material functions associated with individual material features. If smoothness of the material functions is not of concern, the geometric modeling kernel might be used to procedurally calculate the material functions. Alternatively or additionally, explicit construction may be used.

Fourth, an interpolation module should be provided to interpolate the individual material functions of the individual material features to thereby obtain the overall material function for the model. The final material function would be computed subject to the defined material property values at the defined material features, and any specified material property gradients, material feature weights, etc. Inverse distance interpolation, the preferred form of interpolation, may simply be used; alternatively, the user might use the user interface to specify some other form of interpolation.

Fifth, a constraint resolution module can be provided to cooperate with the interpolation module and ensure that any specified constraints (which are input by the user at the interface) are met by the constructed material function. As noted previously, such constraints can include the material properties specified at the material features, proportions of materials (e.g., volume fractions must have proportions which sum to unity), the requirement that material fractions cannot be negative, bounds on the maximum, minimum, or average volume of a material (or on the property values for that material), constraints requiring that materials behave in accordance with some algebraic, differential or integral equations, vector constraints on the orientation of material fibers, and so forth. Application of the constraints amounts to modification of the interpolated material function through a process of fitting or approximation, and this process usually involves additional degrees of freedom (basis functions) whose coefficients are chosen to approximate the specified constraints as accurately as possible.

Finally, a downstream interface module can be provided to enable evaluation of the material function for downstream applications. Downstream applications include analysis, e.g., in a CAD package wherein computerized behavior analysis of the model may be performed (such as a stress/strain analysis of the geometric model if subjected to loads); fabrication, e.g., in a Computer Aided Manufacturing (CAM) application which drives a solid free-form fabrication process to physically construct the geometric model; optimization, e.g., in an application which interfaces with the constraint resolution module to automatically design an overall material function for the geometric model which optimally meets the defined constraints; and visualization.

H. Exemplary Applications

To further illustrate the uses to which the invention might be put, following are several exemplary applications.

H(1). Turbine Vane Modeling

Turbine vanes are formed of high-strength metal coated with heat-resistant ceramic material. The ceramic imparts the necessary heat resistance that the metal lacks, while the metal imparts the strength that the ceramic lacks. The interface between the outer ceramic skin and the inner metal core is made of functionally graded materials (FGM), and cannot be effectively modeled by use of conventional CAD programs which operate under assumptions of material homogeneity, since such programs cannot account for the continuous variation in materials between the skin and the core.

Here, the invention can readily provide a model by treating the inner core and outer skin as two material features in the geometric model of the vane. The outer skin can be defined as 100% ceramic and 0% metal, and the inner core can be defined as 100% metal and 0% ceramic. Since an FGM generally has a material composition in the functionally graded region which varies as a polynomial function of the distance from the region's boundary (and the proportions of the two features must add up to 1), a user can specify the desired constraints to the invention, and thereby obtain a material function which specifies all of the vane's geometry, material properties (here composition), and the property distribution required to meet the defined constraints.

H(2). Bone Modeling

A typical procedure for modeling a bone involves scanning the bone into a set of two-dimensional slices, or a three-dimensional cloud of points, which represent the geometry and tissue density variation throughout the bone. The subsequent steps of modeling and behavior analysis (generally strength analysis) typically require that a traditional CAD model must be generated, following by tedious meshing steps wherein elements of the mesh represent different areas of the bone having different properties.

The invention can instead directly use the data from the digitized images to construct distance fields from the outer surface of the bone, and from any other material features of the bone that require special attention. The density measurements/values reflected in the digital image can be used to constrain and interpolate the density at all points of the bone. The resulting model, which can be generated nearly immediately by the invention (depending on computational speed), avoids the need for model construction and meshing, and can be used immediately for visualization and behavior analysis.

H(3). Modeling of Materials with Periodic/Stochastic Properties

Objects to be modeled often have features with a highly repetitive (periodic) nature; as an example, reflective properties of surfaces are often tailored by forming a repeating pattern, perhaps on a microscopic scale. Where the repeating element is a primitive shape such as triangle, polygon, sphere, or polyhedral structure—for which distance fields/material functions can be readily explicitly computed—one can specify a constraint that the element periodically repeats, and thereby generate a material function which repeats itself through space. In the same manner, constraints can introduce noise and stochastic properties (for example, porosity) into models in order to mimic real-world behavior.

H(4). Varying Properties to Obtain Optimized Models

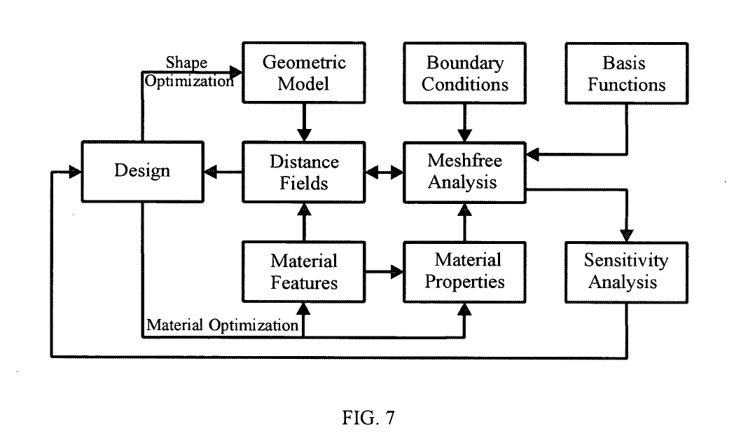

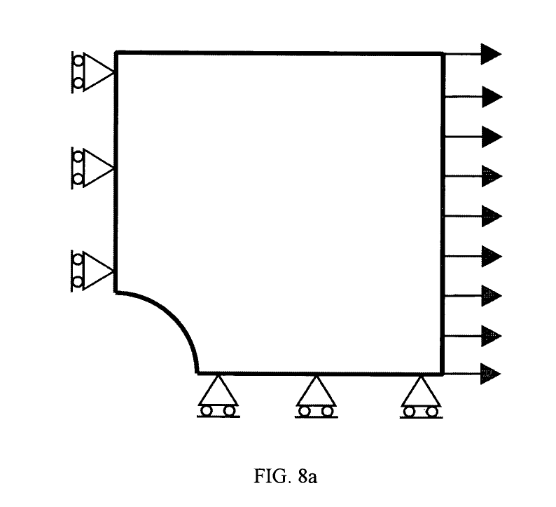

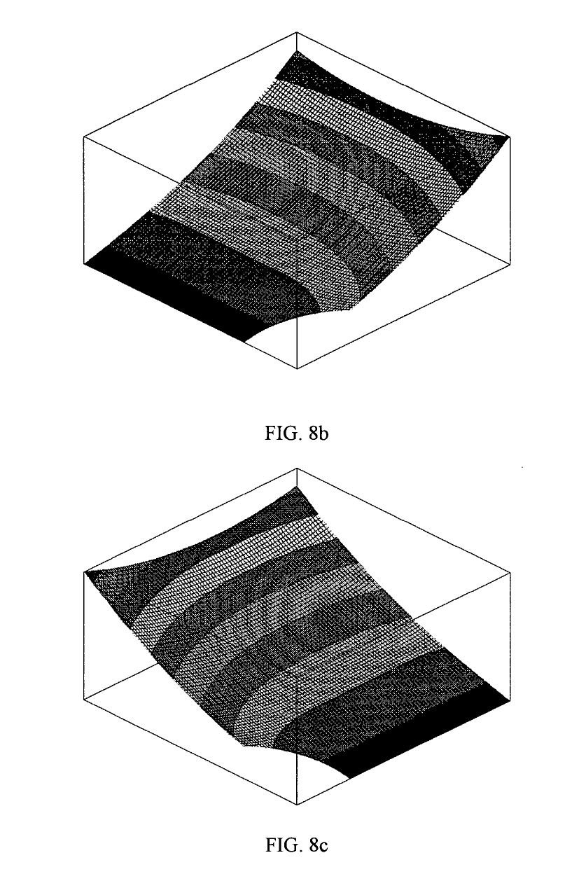

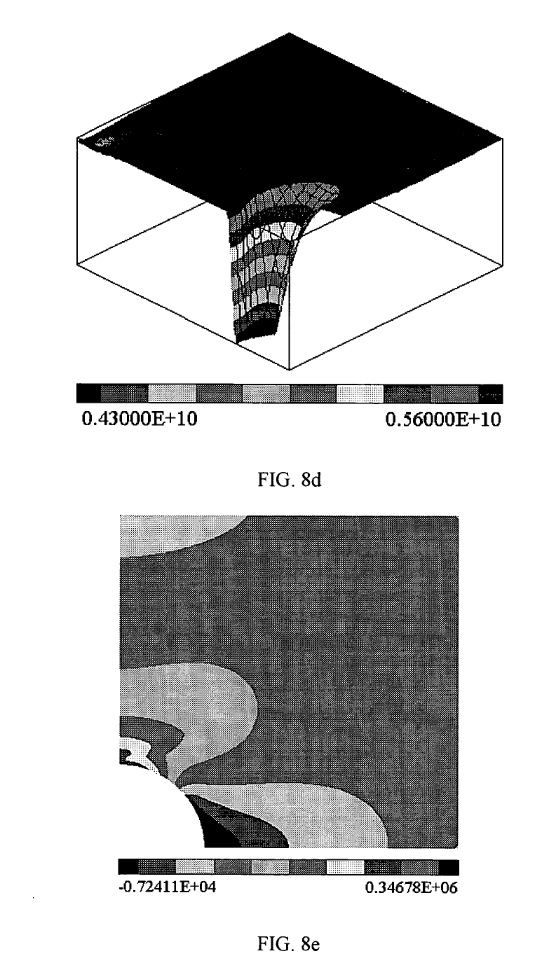

The invention can be combined with other programs which perform behavior analysis, and the invention and behavior analysis package can cooperate to develop geometric models having property distributions which best meet some strength, thermal, electrical, or other properties. Prototypical versions of the invention have been constructed for use with the mesh-free behavior analysis system of U.S. Pat. No. 6,718,291 to Shapiro et al., for which a demonstration version is available (as of July 2004, for 2-D geometric models only) at http://sal-cnc.me.wisc.edu. FIG. 7 schematically illustrates the data processing flow of the material optimization system that results from a combination of the invention with behavior analysis, and FIGS. 8(a)-8(e) illustrate the results of materials optimization in a stressed plate. FIG. 8(a) illustrates the loading of the plate being modeled; FIGS. 8(b) and 8(c) illustrate distance fields defined from the fixed boundaries shown in FIG. 8(a) (i.e., from the two material features of the fixed boundaries); and FIGS. 8(d) and 8(e) respectively show the distributions of Young's modulus E (FIG. 8(d)) and principal stress (FIG. 8(e)) after material property optimization. When the Young's modulus was allowed to vary as shown in FIG. 8(d) in order to minimize stress, rather than being held constant (as would occur in a homogeneous model), the stress concentration about the notched corner dropped from 2.4 to 1.98.

H(5). Varying Geometric Shape to Obtain Optimized Models

In traditional CAD systems, material properties are assigned after the geometric model is completely designed, and are generally assumed to be homogeneous (either universally, or at least within each element into which the model is meshed). The invention allows modeling of geometry and material properties simultaneously. For example, a part designer may start with known material features (such as places where the part will interface with other parts, and thus has a predefined shape), but otherwise does not know what the complete shape of the part will be. The designer can then regard the entire envelope/space in which the part may operate as being the preliminary shape of the part, and may construct a material function which defines properties throughout that entire space. The shape of the final part may then be chosen based on the resulting property distribution, for example, by eliminating those areas consisting primarily of low density material, having higher proportions of more expensive material, or otherwise having characteristics which make these areas good candidates for elimination.

I. Summary

Parameterizing material functions by distance fields leads to a compact, canonical, and unique representation scheme for material properties. To review, a material function—a function representing material property values upon or about an object—may be generated from one or more material features (locations on the object) at which material property values are defined in terms of distance fields to thse features. Possible characteristics for such material functions include:
(a) A normalization order for a normalized distance field associated with each material feature (expression (1));
(b) A finite number of Taylor coefficients (constants or functions) in the distance canonical form (of expression (2)) for each material feature;
(c) An influence coefficient (whether a constant or function) and distance exponent for every feature to be used in weights for transfinite interpolation (as in expression (9));
(d) Constraints on features or interpolated functions;
(e) A finite number of linearly independent basis functions {Xᵢ} representing the function Φ in the remainder term of expression (5).

As previously noted, the use of a field-based representation of material properties may in some cases be computationally expensive. However, when it is considered that discretization also carries substantial computational expense (and carries errors), the advantages of the field-based representation (e.g., guaranteed completeness and analytical properties, the flexible, intuitive, and independent control of material and/or geometric properties, etc.) may nonetheless make it a superior choice.

Two-dimensional examples were generally used in the foregoing description and drawings for sake of simplicity, but the foregoing techniques apply to three-dimensional examples as well.

The foregoing discussion focused on distance functions using Euclidean distances, but other distance measures, such as distances measured along a curve or surface, or using a different metric (e.g. Manhattan metric), can be used instead, and may be more appropriate in some applications.

The invention is not intended to be limited to the examples described above, but rather is intended to be limited only by the claims set out below. Thus, the invention encompasses all different versions that fall literally or equivalently within the scope of these claims.

1. A computer-implemented method for modeling one or more material properties of an object within a geometric model of the object wherein:
A. the model has one or more material features at which one or more material properties are defined, and
B. the model has one or more locations away from the material features at which material properties are undefined;
the method comprising the steps of:
a. defining one or more material functions wherein each material function:
(1) corresponds to one of the material features, and
(2) defines the value of one of the material properties as a function of distance from the material feature;
b. defining material properties at one or more of the locations away from the material features by use of the material functions.

2. The computer-implemented method of claim 1 further comprising the step of performing computerized behavior analysis on the geometric model, wherein the behavior analysis utilizes material properties defined by use of the material functions at one or more of the locations away from the material features.

3. The computer-implemented method of claim 1 further comprising the step of outputting at least some of the defined material properties at one or more of the locations away from the material features.

4. The computer-implemented method of claim 1 wherein material properties are defined throughout the geometric model at all locations away from the material features.

5. The computer-implemented method of claim 1 wherein the step of defining material properties at one or more of the locations away from the material features is performed without discretizing the geometric model.

6. The computer-implemented method of claim 1 wherein the step of defining material properties at one or more of the locations away from the material features includes the step of interpolating the material functions of the material features.

7. The computer-implemented method of claim 6 wherein the material functions of the material features are interpolated by weighted interpolation.

8. The computer-implemented method of claim 7 wherein the weighting accorded the material functions of each material feature is dependent on the distance from that material feature.

9. The computer-implemented method of claim 1 wherein the step of defining the material properties at one or more of the locations away from the material features includes defining a weighting function fixing the relationship between the material properties at one or more of the locations away from the material features.

10. The computer-implemented method of claim 9 wherein the weighting function fixes the material properties at one or more of the locations away from the material features such that they have proportions relative to each other which sum to unity.

11. The computer-implemented method of claim 1 wherein the step of defining material properties at one or more of the locations away from the material features includes:
a. constructing a material function from
(1) the material functions corresponding to the material features;
(2) predefined basis functions having unknown coefficients;
(3) predefined constraints affecting the values of the material functions;
b. determining values for the unknown coefficients of the basis functions such that the constraints are satisfied to some desired degree of accuracy; and
c. using the coefficients to define material properties at one or more of the locations away from the material features.

12. The computer-implemented method of claim 1 wherein each material function is normalized.

13. The computer-implemented method of claim 1 wherein the geometric model of the object is derived from an image of the object, and wherein the image is defined by a collection of discrete data values.

14. The computer-implemented method of claim 13 wherein the defined material properties at the material features are derived from data values in the image of the object.

15. The computer-implemented method of claim 1 wherein both:
a. the defined material properties at the material features, and
b. the material functions,
are derived from an image of the object.
